(19) United States
(12) Patent Application Publication
(10) Pub. No.: US 2012/0162535 A1
(43) Pub. Date: Jun. 28, 2012

(54) DIGITAL BROADCASTING RECEIVER AND COMPUTER-READABLE RECORDING MEDIUM STORING PROGRAM FOR DIGITAL BROADCASTING RECEPTION

(75) Inventor: Takayuki Kida, Takarazuka City (JP)

(73) Assignee: SANYO ELECTRIC CO., LTD., Moriguchi City (JP)

(21) Appl. No.: 13/338,655

(22) Filed: Dec. 28, 2011

(30) Foreign Application Priority Data
Dec. 28, 2010 (JP) 2010-291704

(51) Int. Cl. H04N 5/50

(52) U.S. Cl. 348/731; 348/E05.097

(57) ABSTRACT

A digital broadcasting receiver includes a nonvolatile memory, a tuner that performs a tuning process on a digital broadcasting wave signal so as to generate a transport stream, an MT obtaining portion that obtains an NIT contained in the transport stream output from the tuner, and a control portion that controls the nonvolatile memory to store a whole or a part of the NIT obtained by the NIT obtaining portion, and can determine a service to be received using the whole or the part of the MT stored in the nonvolatile memory when a tuning instruction issued.

### CROSS-REFERENCE TO RELATED APPLICATIONS

This nonprovisional application claims priority under 35 U.S.C. §119(a) on Patent Application No. 2010-291704 filed in Japan on Dec. 28, 2010, the entire contents of which are hereby incorporated by reference.

### BACKGROUND OF THE INVENTION

1. Field of the Invention

The present invention relates to a digital broadcasting receiver and a computer-readable recording medium that stores a program for digital broadcasting reception.

2. Description of Related Art

In reception of a digital broadcasting by tuning in which a physical channel is designated, information of a broadcasting station cannot be obtained before a network information table (NIT) is received. Therefore, before the NIT is received, it cannot be known which broadcasting station can be received in the designated physical channel

Therefore, a time from a tuning instruction to provision of image and sound becomes a sum of the following Time (A), Time (B), Time (C), and Time (D). In addition, in the case of channel scan of detecting and listing services that can be received in a current reception place, a time necessary for recognizing a physical channel containing services that can be received becomes a sum of the following Time (A) and Time (B).

Time (A) is a time from designation of a physical channel until a demodulation portion (for example, an orthogonal frequency division multiplexing (OFDM) demodulation portion) can generate a transport stream.

Time (B) is a time until the NIT is obtained from a transport stream.

Time (C) is a time until a service to be viewed is determined from NIT information, and it is checked whether or not the determined service is actually broadcasted by obtaining a program association table (PAT), and a program map table (PMT) is obtained.

Time (D) is a time until a packet identification (PID) of an image signal and a PID of a sound signal are determined from the PMT, and image and sound signals are decoded so that the image and sound can be provided.

As described above, in the digital broadcasting reception, it is necessary to first obtain the NIT indicating the broadcasting station information and the PAT for providing the image and sound as keys. Retransmission periods are usually one second for the NIT and 0.1 seconds for the PAT. Therefore, it takes long time to wait for receiving the NIT, namely the above-mentioned Time (B) becomes long, which causes an increase of a time from the tuning instruction until provision of image and sound, or a time for channel scan.

### SUMMARY OF THE INVENTION

A digital broadcasting receiver according to the present invention includes:

a nonvolatile memory;

a tuner that performs a tuning process on a digital broadcasting wave signal so as to generate a transport stream;

an NIT obtaining portion that obtains an NIT contained in the transport stream output from the tuner; and

a control portion that controls the nonvolatile memory to store a whole or a part of the NIT obtained by the NIT obtaining portion, and can determine a service to be received using the whole or the part of the NIT stored in the nonvolatile memory when a tuning instruction issued.

Meanings and effects of the present invention will be apparent from the following description of an embodiment. However, the embodiment described below is merely an embodiment of the present invention, and meanings of the present invention and terms of individual elements thereof are not limited to those described in the following embodiment.

### BRIEF DESCRIPTION OF THE DRAWINGS

FIG. 1 is a block diagram illustrating a schematic structure of a ground-wave digital television broadcasting receiver according to an embodiment of the present invention.

FIG. 2 is a flowchart illustrating a process for storing a latest NIT.

FIG. 3 is a flowchart illustrating an action of the ground-wave digital television broadcasting receiver according to an embodiment of the present invention illustrated in FIG. 1 when a tuning instruction is issued to the receiver.

FIG. 4 is a flowchart illustrating an action of the ground-wave digital television broadcasting receiver according to an embodiment of the present invention illustrated in FIG. 1 when the receiver performs channel scan.

FIG. 5 is a flowchart illustrating another action of the ground-wave digital television broadcasting receiver according to an embodiment of the present invention illustrated in FIG. 1 when a tuning instruction is issued to the receiver.

FIG. 6 is a flowchart illustrating an example of a process performed after service tuning when determining a service to be viewed based on pseudo-NIT.

### DETAILED DESCRIPTION OF THE PREFERRED EMBODIMENTS

Hereinafter, an embodiment of the present invention will be described with reference to the attached drawings. Here, there is described an example in which the present invention is applied to a ground-wave digital television broadcasting receiver as an example of a digital broadcasting receiver according to the present invention.

(Structure of Receiver)

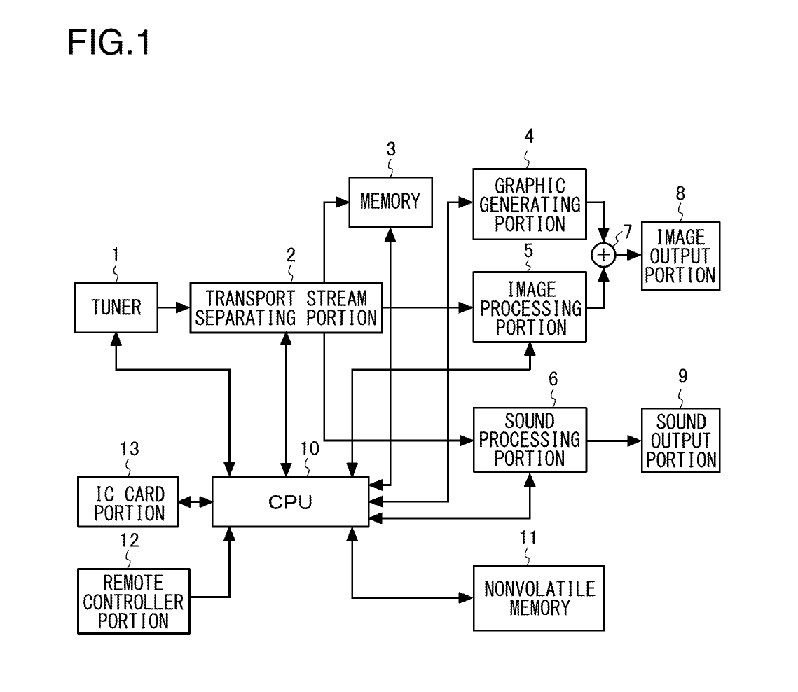

A schematic structure of a ground-wave digital television broadcasting receiver according to an embodiment of the present invention is illustrated in FIG. 1. The ground-wave digital television broadcasting receiver according to an embodiment of the present invention illustrated in FIG. 1 includes a tuner 1, a transport stream separating portion 2, a memory 3, a graphic generating portion 4, an image processing portion 5, a sound processing portion 6, a multiplexer 7, an image output portion 8, a sound output portion 9, a central processing unit (CPU) 10, a nonvolatile memory 11, a remote controller portion 12, and an IC card portion 13.

A ground-wave digital television broadcasting wave signal is sent from an antenna (not shown) to the tuner 1. The tuner 1 performs a tuning process (high frequency process and demodulation process) on the ground-wave digital television broadcasting wave signal so as to generate a transport stream.

The transport stream separating portion 2 performs a packet demodulation process on the transport stream output from the tuner 1. In the transport stream separating portion 2, the packet is separated into Moving Picture Experts Group (MPEG) data and attached information such as program information. MPEG image data separated by the transport stream separating portion 2 is sent to the image processing portion (image decoding portion) 5. MPEG sound data separated by the transport stream separating portion 2 is sent to the sound processing portion (sound decoding portion) 6. The attached information separated by the transport stream separating portion 2 is stored in the memory 3. The attached information contains NIT, PAT, PMT, and the like.

The CPU 10 sends information for tuning to the tuner 1 and the transport stream separating portion 2. In addition, the CPU 10 can communicate information with each of the memory 3, the nonvolatile memory 11, and the IC card portion 13. In addition, the CPU 10 receives an output signal of the remote controller portion 12 that receives a remote control signal transmitted from a remote control transmitter (not shown). Further, the CPU 10 sends to the graphic generating portion 4 an on-screen display (OSD) control signal for on-screen display of a program information screen, various setting screens, and the like. The graphic generating portion 4 generates display data of the program information screen, the various setting screen, and the like based on the OSD control signal output from the CPU 10 and sends the generated display data to the multiplexer 7.

The image processing portion 5 demodulates the MPEG image data sent from the transport stream separating portion 2 in accordance with an instruction from the CPU 10 and sends the demodulated result to the multiplexer 7. The multiplexer 7 performs a superimposing process of the display data sent from the graphic generating portion 4 on the image data sent from the image processing portion 5 and sends the result to the image output portion (display device) 8.

The sound processing portion 6 demodulates the MPEG sound data sent from the transport stream separating portion 2 in accordance with an instruction from the CPU 10 and sends the demodulated result to the sound output portion (speaker) 9.

(Storing of Latest NIT)

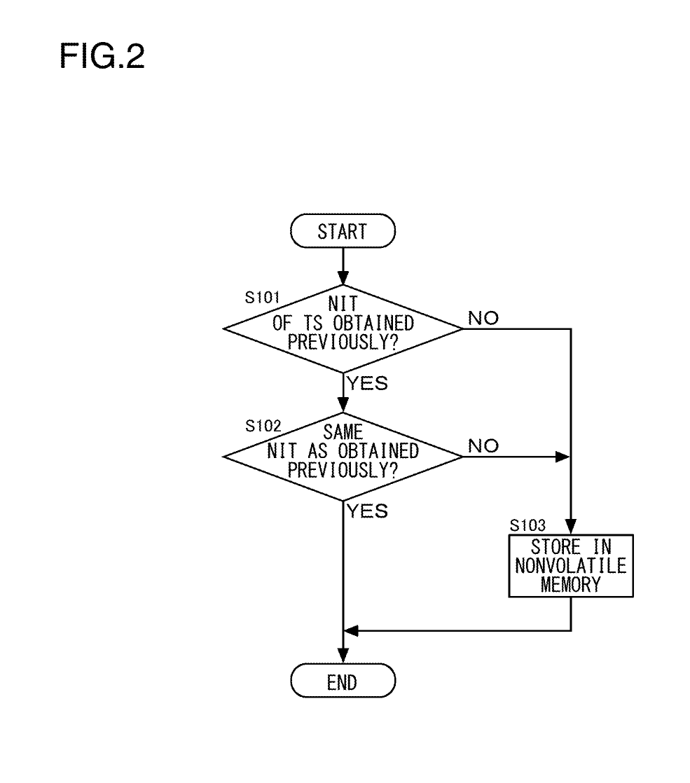

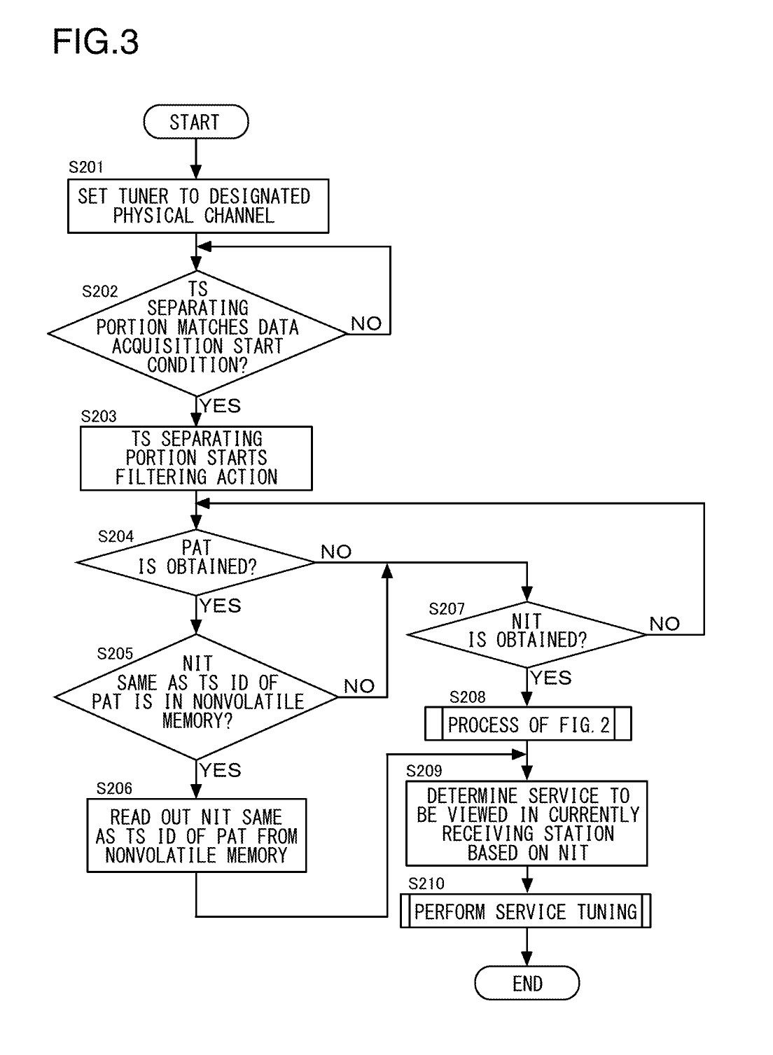

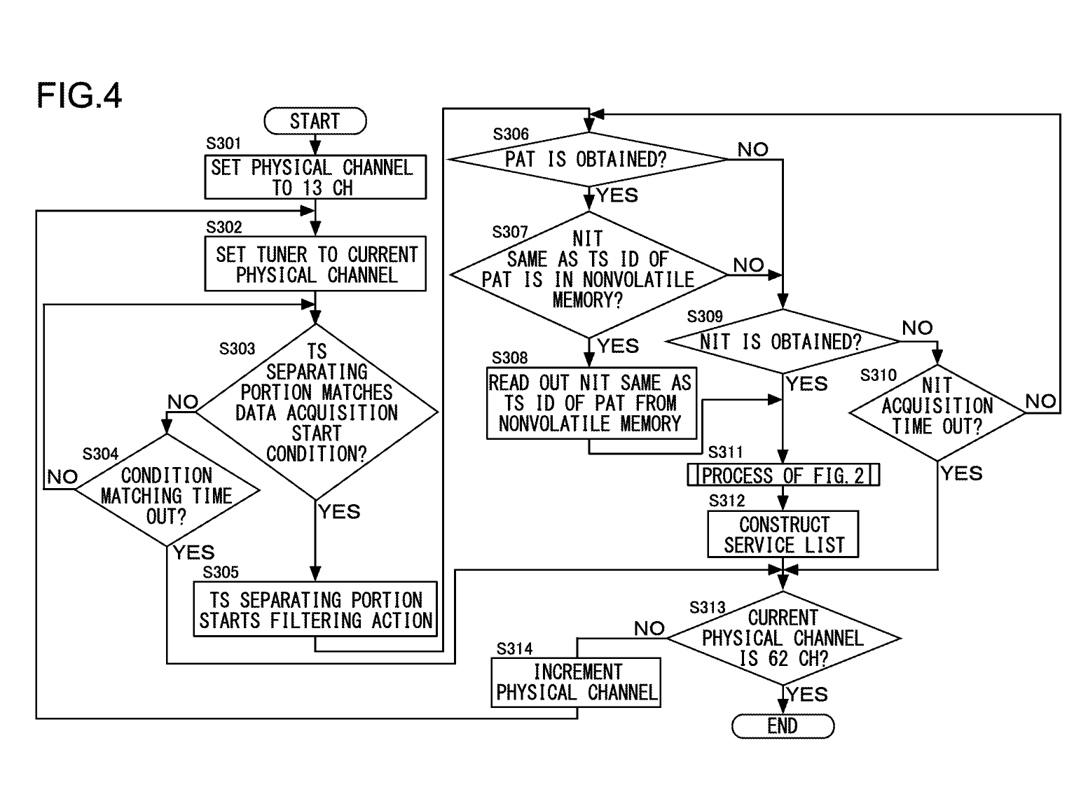

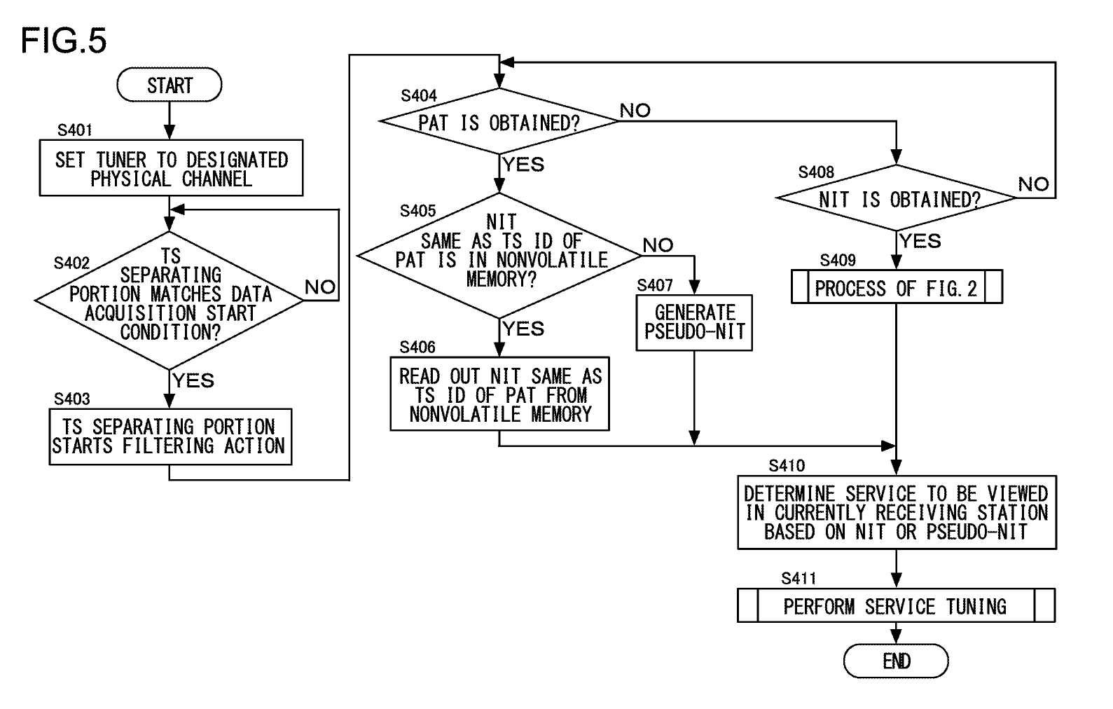

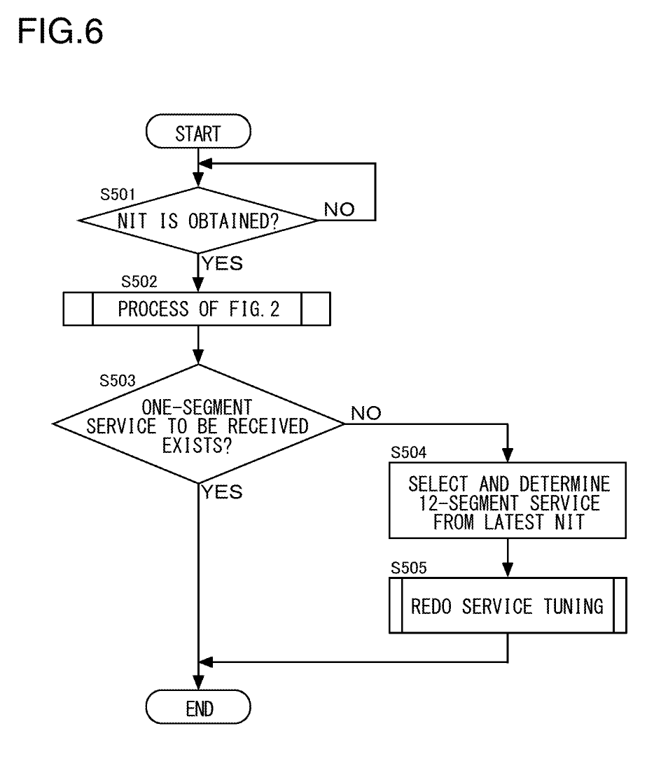

In the ground-wave digital television broadcasting receiver according to an embodiment of the present invention illustrated in FIG. 1, the CPU 10 decides whether or not the transport stream separating portion 2 has obtained NIT. As a result of the decision, if it is decided that the transport stream separating portion 2 has obtained the NIT (for example, “YES in Step S207” illustrated in FIG. 3, “YES in Step S309” illustrated in FIG. 4, “YES in Step S409” illustrated in FIG. 5, “YES in Step S503” illustrated in FIG. 6, and the like), the action shown in the flowchart of FIG. 2 is started.

In the action shown in the flowchart of FIG. 2, the CPU 10 first decides whether or not the NIT obtained by the transport stream separating portion 2 this time is the same as the NIT of the transport stream that was obtained previously (Step S101). This decision can be performed by checking whether or not the nonvolatile memory 11 has already stored the NIT in which the same transport ID is described as that described in the NIT obtained this time.

If it is decided that the NIT obtained this time by the transport stream separating portion 2 is the same NIT of the transport stream that was obtained previously (YES in Step S101), the CPU 10 decides whether or not content of the NIT obtained this time by the transport stream separating portion 2 is the same as content of the NIT that is already stored in the nonvolatile memory 11 and in which the same transport ID is described as the transport ID described in the NIT obtained this time (Step S102).

If it is decided that the content of the NIT obtained this time by the transport stream separating portion 2 is the same as the content of the NIT that is already stored in the nonvolatile memory 11 and in which the same transport ID is described as the transport ID described in the MT obtained this time (YES in Step S102), the action in the flowchart is finished without storing the NIT.

On the other hand, if it is decided in Step S101 that the NIT obtained this time by the transport stream separating portion 2 is not the same as the NIT of the transport stream that was obtained previously (NO in Step S101), or if it is decided in Step S102 that the content of the NIT obtained this time by the transport stream separating portion 2 is not the same as the content of the NIT that is already stored in the nonvolatile memory 11 and in which the same transport ID is described as the transport ID described in the NIT obtained this time (NO in Step S102), because the NIT obtained this time is the latest NIT, the CPU 10 controls the nonvolatile memory 11 to store the NIT obtained this time (Step S103), and then finishes the action in the flowchart.

In this way, because the latest NIT is stored in the nonvolatile memory 11, in the ground-wave digital television broadcasting receiver according to an embodiment of the present invention illustrated in FIG. 1, the latest NIT can be used even when starting from a power-off state.

(Action when Tuning Instruction is Issued)

Next, with reference to the flowchart of FIG. 3, there will be described an action of the receiver when a user performs the channel selection operation with the remote control transmitter (not shown), so that the tuning instruction is issued to the ground-wave digital television broadcasting receiver according to an embodiment of the present invention illustrated in FIG. 1.

When the tuning instruction is issued, the CPU 10 first sets various parameters to the tuner 1 so that tuning of a designated physical channel is performed in a state where data obtaining action of the transport stream separating portion 2 is stopped (Step S201).

In Step S202 after Step S201, the CPU 10 decides whether or not the transport stream separating portion 2 matches a data acquisition start condition. Note that in this embodiment, the time point when the transport stream separating portion 2 matches the data acquisition start condition means a time point when a predetermined time passes after the above-mentioned various parameters have been set to the tuner 1, or a time point it is checked that OFDM demodulation in the tuner 1 has been normally decoded.

When the transport stream separating portion 2 matches the data acquisition start condition (YES in Step S202), the CPU 10 requests the transport stream separating portion 2 to obtain the NIT and PAT, and the transport stream separating portion 2 starts a packet separating process (filtering action) in response to the request (Step S203).

In Step S204 after Step S203, the CPU 10 decides whether or not the transport stream separating portion 2 has obtained the PAT. As described above, the NIT has a retransmission period of usually one second, and the PAT has a retransmission period of usually 0.1 seconds. Therefore, when the CPU 10 requests the transport stream separating portion 2 to obtain the PAT and NIT, there are many cases where the PAT is obtained prior to the NIT. In other words, there is a possibility that it is decided in Step S204 that the transport stream separating portion 2 has obtained the PAT is higher than a possibility that it is decided in Step S207 described later that the transport stream separating portion 2 has obtained the NIT.

If it is decided that the transport stream separating portion 2 has obtained the PAT (YES in Step S204), the CPU 10 decides whether or not the nonvolatile memory 11 stores the NIT in which the same transport ID is described as that described in the PAT obtained by the transport stream separating portion 2 (Step S205).

Then, if it is decided that the nonvolatile memory 11 stores the NIT in which the same transport ID is described as that described in the PAT obtained by the transport stream separating portion 2 (YES in Step S205), in order to obtain information of a broadcasting station to be tuned (information about how many and what types of services the broadcasting station to be tuned has), the CPU 10 reads out a whole or a part of the NIT in which the same transport ID is described as that described in the PAT obtained by the transport stream separating portion 2 from the nonvolatile memory 11 (Step S206), and the process goes to Step S209 described later.

On the other hand, in the decision of Step S204, if it is decided that the transport stream separating portion 2 has not obtained the PAT (NO in Step S204), or in the decision of Step S205, if it is decided that the nonvolatile memory 11 does not store the NIT in which the same transport ID is described as that described in the PAT obtained by the transport stream separating portion 2 (NO in Step S205), the CPU 10 decides whether or not the transport stream separating portion 2 has obtained the NIT (Step S207).

If it is decided that the transport stream separating portion 2 has not obtained the NIT (NO in Step S207), the process goes back to Step S204. On the contrary, if it is decided that the transport stream separating portion 2 has obtained the NIT (YES in Step S207), the process illustrated in FIG. 2, namely the process of storing only the latest NIT in the nonvolatile memory 11 is performed (Step S208), and then the process goes to Step S209.

In Step S209, the CPU 10 determines a service to be viewed of the broadcasting station that is currently received based on a whole or a part of the NIT read out from the nonvolatile memory 11 or the NIT obtained by the transport stream separating portion 2. This determination process is performed uniquely as a result of monitoring reception environment based on information or setting of the tuner 1 among a plurality of services provided by the broadcasting station that is currently received, or is performed by user's instruction.

In Step S210 after Step S209, service tuning is performed, and then the action shown in the flowchart of FIG. 3 is finished. In the service tuning, the CPU 10 instructs the transport stream separating portion 2 to obtain the PAT and PMT, so as to determine the PID for deciding image and sound streams belonging to the determined service by using the obtained PAT and PMT. Note that if Conditional Access is used, PID of Entitlement Control Message (ECM) is recognized, the ECM is obtained, information is obtained from the IC card portion 13, and then descrambling is performed. As described above, when it becomes ready to process the image and sound, the MPEG image data and the MPEG sound data are supplied from the transport stream separating portion 2 to an image processing (image decoding) portion 5 and a sound processing (sound decoding) portion 6, respectively, in accordance with control of the CPU 10. Then, the image is reproduced by the image output portion 7, and the sound is reproduced by the sound output portion 8.

By the action described above, if the transport stream separating portion 2 obtains the PAT prior to the NIT, and if a whole or a part of the NIT corresponding to the obtained PAT is already stored in the nonvolatile memory 11, the whole or the part of the NIT can be used for determining the service to be viewed in the broadcasting station that is currently received. Therefore, it is possible to shorten the time period from the tuning instruction to the image and sound provision.

(Channel Scan Action)

Next, with reference to the flowchart of FIG. 4, there will be described an action of the receiver when the user operates the remote control transmitter (not shown) to instruct to perform channel scan, so that the ground-wave digital television broadcasting receiver according to an embodiment of the present invention illustrated in FIG. 1 performs the channel scan.

When the channel scan is performed, the CPU 10 first sets the physical channel to 13 CH (Step S301).

In Step S302 after Step S301, the CPU 10 sets various parameters to the tuner 1 so that the tuning of the set physical channel is performed in a state where the data obtaining action of the transport stream separating portion 2 is stopped (Step S302).

In Step S303 after Step S302, the CPU 10 decides whether or not the transport stream separating portion 2 matches the data acquisition start condition.

When a predetermined time-out set time has passed after the first decision in Step S303, if the transport stream separating portion 2 does not match the data acquisition start condition (YES in Step S304), the channel is not a receivable physical channel, and so the process goes to Step S313 that will be described later. On the contrary, if the transport stream separating portion 2 matches the data acquisition start condition in the time-out set time (YES in Step S303), the CPU 10 requests the transport stream separating portion 2 to obtain the NIT and PAT, and the transport stream separating portion 2 starts the packet separating process (filtering action) in response to the request (Step S305).

In Step S306 after Step S305, the CPU 10 decides whether or not the transport stream separating portion 2 has obtained the PAT.

If it is decided that the transport stream separating portion 2 has obtained the PAT (YES in Step S306), the CPU 10 decides whether or not the nonvolatile memory 11 stores the NIT in which the same transport ID is described as that described in the PAT obtained by the transport stream separating portion 2 (Step S307).

Then, if it is decided that the nonvolatile memory 11 stores the NIT in which the same transport ID is described as that described in the PAT obtained by the transport stream separating portion 2 (YES in Step S307), in order to obtain information of a broadcasting station to be tuned (information about how many and what types of services the broadcasting station to be tuned has), the CPU 10 reads out a whole or a part of the NIT in which the same transport ID is described as that described in the PAT obtained by the transport stream separating portion 2 from the nonvolatile memory 11 (Step S308), and the process goes to Step S311 described later.

On the other hand, if it is decided in the decision of Step S306 that the transport stream separating portion 2 has not obtained the PAT (NO in Step S306), or if it is decided in the decision of Step S307 that the nonvolatile memory 11 does not store the NIT in which the same transport ID is described as that described in the PAT obtained by the transport stream separating portion 2 (NO in Step S307), the CPU 10 decides whether or not the transport stream separating portion 2 has obtained the NIT (Step S309).

If the transport stream separating portion 2 has not obtained the NIT even after a predetermined time-out set time from the first decision in Step S309 (YES in Step S310), the channel is not a receivable physical channel, and so the process goes to Step S313 described later. On the contrary, if it is decided that the transport stream separating portion 2 has obtained the NIT in the time-out set time (YES in Step S309), the process illustrated in FIG. 2, namely the process of storing only the latest NIT in the nonvolatile memory 11 is performed (Step S311), and then the process goes to Step S312.

In Step S312, the CPU 10 constructs (updates) a service list generated by detecting services that can be received in a current reception place based on a whole or a part of the NIT read out from the nonvolatile memory 11 or the NIT obtained by the transport stream separating portion 2, and controls the nonvolatile memory 11 to store the service list. Then the process goes to Step S313.

In Step S313, the CPU 10 decides whether or not a physical channel that is currently set is 62 CH. If the currently set physical channel is not 62 CH (NO in Step S313), the physical channel is incremented by 1 CH for resetting, and the process goes back to Step S302. On the other hand, if the currently set physical channel is 62 CH (YES in Step S313), the channel scan is finished.

By the action described above, if the transport stream separating portion 2 obtains the PAT prior to the NIT, and if the nonvolatile memory 11 has already stores a whole or a part of the NIT corresponding to the obtained PAT, the whole or the part of the NIT can be used for constructing (updating) the service list. Therefore, the time for the channel scan can be shortened. If the ground-wave digital television broadcasting receiver according to an embodiment of the present invention illustrated in FIG. 1 is a car-mounted receiver, a position of the receiver changes frequently when the car moves. Therefore, the channel scan is used repeatedly, and so the reduction of time for the channel scan by the action in the flowchart of FIG. 4 is particularly useful.

(Others)

Although the embodiment of the present invention is described above, the present invention is not limited to this, which can be modified variously within the scope without deviating from the spirit of the present invention.

For instance, in the embodiment described above, a whole of the latest NIT is stored in the nonvolatile memory 11, but it is possible to store only a necessary part of the latest NIT in the nonvolatile memory 11.

In addition, for example, instead of the action shown in the flowchart of FIG. 3, the action shown in the flowchart of FIG. 5 may be performed. In the action shown in the flowchart of FIG. 3, even if the transport stream separating portion 2 obtains the PAT prior to the NIT, if a whole or a part of the NIT corresponding to the obtained PAT is not stored in the nonvolatile memory 11, the time from the tuning instruction to the provision of contents is the same as the conventional receiver. In contrast, in the action shown in the flowchart of FIG. 5, if the transport stream separating portion 2 obtains the PAT prior to the NIT, even if a whole or a part of the NIT corresponding to the obtained PAT is not stored in the nonvolatile memory 11, the time from the tuning instruction to the provision of contents can be shortened.

Hereinafter, the action shown in the flowchart of FIG. 5 will be described.

When the tuning instruction is issued, the CPU 10 first sets various parameters to the tuner 1 so that the tuning of the designated physical channel is performed in a state where data obtaining action of the transport stream separating portion 2 is stopped (Step S401).

In Step S402 after Step S401, the CPU 10 decides whether or not the transport stream separating portion 2 matches the data acquisition start condition.

If the transport stream separating portion 2 matches the data acquisition start condition (YES in Step S402), the CPU 10 requests the transport stream separating portion 2 to obtain the NIT and PAT, and the transport stream separating portion 2 starts the packet separating process (filtering action) in response to the request (Step S403).

In Step S404 after Step S403, the CPU 10 decides whether or not the transport stream separating portion 2 has obtained the PAT.

If it is decided that the transport stream separating portion 2 has obtained the PAT (YES in Step S404), the CPU 10 decides whether or not the nonvolatile memory 11 stores the NIT in which the same transport ID is described as that described in the PAT obtained by the transport stream separating portion 2 (Step S405).

Then, if it is decided that the nonvolatile memory 11 stores the NIT in which the same transport ID is described as that described in the PAT obtained by the transport stream separating portion 2 (YES in Step S405), in order to obtain information of a broadcasting station to be tuned (information about how many and what types of services the broadcasting station to be tuned has), the CPU 10 reads out a whole or a part of the NIT in which the same transport ID is described as that described in the PAT obtained by the transport stream separating portion 2 from the nonvolatile memory 11 (Step S406), and the process goes to Step S410 described later.

On the contrary, if it is decided that the nonvolatile memory 11 does not store the NIT in which the same transport ID is described as that described in the PAT obtained by the transport stream separating portion 2 (NO in Step S405), the CPU 10 generates data that can match information that is considered to be contained in the NIT in a pseudo manner (pseudo-NIT) using known information such as a remote control key ID corresponding to the designated physical channel, and controls the nonvolatile memory 11 to store the pseudo-NIT (Step S407). Then, the process goes to Step S410 described later. Note that it is possible to use a Program Number described in the PAT when the pseudo-NIT is generated.

On the other hand, in the decision of Step S404, if it is decided that the transport stream separating portion 2 has not obtained the PAT (NO in Step S404), the CPU 10 decides whether or not the transport stream separating portion 2 has obtained the NIT (Step S408).

If it is decided that the transport stream separating portion 2 has not obtained the NIT (NO in Step S408), the process goes back to Step S404. On the contrary, if it is decided that the transport stream separating portion 2 has obtained the NIT (YES in Step S408), the process illustrated in FIG. 2, namely the process of storing only the latest NIT in the nonvolatile memory 11 is performed (Step S409), and then the process goes to Step S410.

In Step S410, the CPU 10 determines a service to be viewed in the broadcasting station that is currently received based on a whole or a part of the NIT read out from the nonvolatile memory 11, the NIT obtained by the transport stream separating portion 2, or the pseudo-NIT read out from the nonvolatile memory 11.

In Step S411 after Step S410, the service tuning is performed, and then the action shown in the flowchart of FIG. 5 is finished.

In Step S410, if the CPU 10 decides the service to be viewed in the broadcasting station that is currently received based on the pseudo-NIT read out from the nonvolatile memory 11, wrong service tuning may be performed. Therefore, if the CPU 10 decides the service to be viewed in the broadcasting station that is currently received based on the pseudo-NIT read out from the nonvolatile memory 11 in Step S410, it is desirable to check whether or not the service tuning is correct after finishing the action shown in the flowchart of FIG. 5, and to perform a process of redoing the service tuning if wrong service tuning has been performed.

For instance, in Step S410, if the CPU 10 determines the service to be viewed in the broadcasting station that is currently received to be a one-segment service for moving objects based on the pseudo-NIT read out from the nonvolatile memory 11, it is preferred to perform the action shown in the flowchart of FIG. 6 after finishing the action shown in the flowchart of FIG. 5. However, when using the Program Number described in the PAT when the pseudo-NIT is generated, it is not necessary to perform the action shown in the flowchart of FIG. 6 because presence or absence of the one-segment service is correctly described in the pseudo-NIT.

Hereinafter, the action shown in the flowchart of FIG. 6 will be described.

First, the CPU 10 decides whether or not the transport stream separating portion 2 has obtained the NIT (Step S501). If it is decided that the transport stream separating portion 2 has obtained the NIT (YES in Step S501), the process illustrated in FIG. 2, namely the process of storing only the latest NIT in the nonvolatile memory 11 is performed (Step S502), and then the process goes to Step S503.

In Step S503, the CPU 10 decides whether or not the one-segment service to be received exists in the designated physical channel based on the obtained NIT. If the one-segment service to be received exists in the designated physical channel (YES in Step S503), the action shown in the flowchart of FIG. 6 is finished as it is. On the other hand, if the one-segment service to be received does not exist in the designated physical channel (NO in Step S503), the CPU 10 determines the service to be viewed in the broadcasting station that is currently received to be a 12-segment service for fixed receivers (Step S504) based on the latest NIT obtained by the transport stream separating portion 2, and redoes the service tuning in accordance with the determination (Step S505). After that, the action shown in the flowchart of FIG. 6 is finished.

Note that the program for digital broadcasting reception that makes the computer function as a control portion in the digital broadcasting receiver according to the present invention can be stored in a computer-readable recording medium for distribution or can be distributed via a network, for example.

What is claimed is:

1. A digital broadcasting receiver comprising:
a nonvolatile memory;
a tuner that performs a tuning process on a digital broadcasting wave signal so as to generate a transport stream;
an NIT obtaining portion that obtains an NIT contained in the transport stream output from the tuner; and
a control portion that controls the nonvolatile memory to store a whole or a part of the NIT obtained by the NIT obtaining portion, and can determine a service to be received using the whole or the part of the NIT stored in the nonvolatile memory when a tuning instruction issued.

2. The digital broadcasting receiver according to claim 1, wherein when the digital broadcasting receiver performs the channel scan, the control portion can construct a service list generated by detecting and listing services that can be received in a current reception place using the whole or the part of the NIT stored in the nonvolatile memory.

3. The digital broadcasting receiver according to claim 1, further comprising a PAT obtaining portion that obtains a PAT contained in the transport stream output from the tuner, wherein
when the control portion uses the whole or the part of the NIT stored in the nonvolatile memory, the whole or the part of the NIT corresponding to the PAT obtained by the PAT obtaining portion is used.

4. The digital broadcasting receiver according to claim 2, further comprising a PAT obtaining portion that obtains a PAT contained in the transport stream output from the tuner, wherein
when the control portion uses the whole or the part of the NIT stored in the nonvolatile memory, the whole or the part of the NIT corresponding to the PAT obtained by the PAT obtaining portion is used.

5. The digital broadcasting receiver according to claim 3, wherein when a tuning instruction is issued, if a whole or a part of the NIT corresponding to the PAT obtained by the PAT obtaining portion is not stored in the nonvolatile memory, the control portion generates data that can match information that is considered to be contained in the NIT corresponding to the PAT obtained by the PAT obtaining portion, and determines a service to be received using the data.

6. The digital broadcasting receiver according to claim 4, wherein when a tuning instruction issued, if a whole or a part of the NIT corresponding to the PAT obtained by the PAT obtaining portion is not stored in the nonvolatile memory, the control portion generates data that can match information that is considered to be contained in the NIT corresponding to the PAT obtained by the PAT obtaining portion, and determines a service to be received using the data.

7. The digital broadcasting receiver according to claim 5, when the control portion determines the service to be received using the data, the control portion checks whether or not the service tuning is correct after determining the service to be received, and performs a process of redoing the service tuning if wrong service tuning has been performed.

8. The digital broadcasting receiver according to claim 6, when the control portion determines the service to be received using the data, the control portion checks whether or not the service tuning is correct after determining the service to be received, and performs a process of redoing the service tuning if wrong service tuning has been performed.

9. A computer-readable recording medium that stores a program for a computer to perform the steps, the computer being disposed in a digital broadcasting receiver together with a nonvolatile memory, a tuner that performs a tuning process on a digital broadcasting wave signal so as to generate a transport stream, and an NIT obtaining portion that obtains an NIT contained in the transport stream output from the tuner, the steps comprising:
controlling the nonvolatile memory to store a whole or a part of the NIT obtained by the NIT obtaining portion; and
determining a service to be received using the whole or the part of the NIT stored in the nonvolatile memory when a tuning instruction issued.

10. The computer-readable recording medium according to claim 9, wherein when the digital broadcasting receiver performs the channel scan, the computer can construct a service list generated by detecting and listing services that can be received in a current reception place using the whole or the part of the NIT stored in the nonvolatile memory.

11. The computer-readable recording medium according to claim 9, wherein
the digital broadcasting receiver further includes a PAT obtaining portion that obtains a PAT contained in the transport stream output from the tuner, and
when the computer uses the whole or the part of the NIT stored in the nonvolatile memory, the whole or the part of the NIT corresponding to the PAT obtained by the PAT obtaining portion is used.

12. The computer-readable recording medium according to claim 10, wherein
the digital broadcasting receiver further includes a PAT obtaining portion that obtains a PAT contained in the transport stream output from the tuner, and
when the computer uses the whole or the part of the NIT stored in the nonvolatile memory, the whole or the part of the NIT corresponding to the PAT obtained by the PAT obtaining portion is used.

13. The computer-readable recording medium according to claim 11, wherein the program makes the computer perform the step of generating data that can match information that is considered to be contained in the MT corresponding to the PAT obtained by the PAT obtaining portion, and determining a service to be received using the data, when a tuning instruction is issued to the digital broadcasting receiver, if a whole or a part of the NIT corresponding to the PAT obtained by the PAT obtaining portion is not stored in the nonvolatile memory.

14. The computer-readable recording medium according to claim 12, wherein the program makes the computer perform the step of generating data that can match information that is considered to be contained in the NIT corresponding to the PAT obtained by the PAT obtaining portion, and determining a service to be received using the data, when a tuning instruction is issued to the digital broadcasting receiver, if a whole or a part of the NIT corresponding to the PAT obtained by the PAT obtaining portion is not stored in the nonvolatile memory.

15. The computer-readable recording medium according to claim 13, wherein the program makes the computer perform the steps of checking whether or not the service tuning is correct after determining the service to be received, and redoing the service tuning if wrong service tuning has been performed, when the computer determines the service to be received using the data.

16. The computer-readable recording medium according to claim 14, wherein the program makes the computer perform the steps of checking whether or not the service tuning is correct after determining the service to be received, and redoing the service tuning if wrong service tuning has been performed, when the computer determines the service to be received using the data.
